(19) United States
(12) Patent Application Publication
(10) Pub. No.: US 2022/0119307 A1
(43) Pub. Date: Apr. 21, 2022

(54) METHOD FOR PRODUCING CHEMICALLY STRENGTHENED GLASS AND CHEMICALLY STRENGTHENED GLASS

(71) Applicant: AGC Inc., Tokyo (JP)

(72) Inventors: Takumi UMADA, Tokyo (JP); Yusuke ARAI, Tokyo (JP); Qing LI, Tokyo (JP)

(73) Assignee: AGC Inc., Tokyo (JP)

(21) Appl. No.: 17/562,240

(22) Filed: Dec. 27, 2021

Related U.S. Application Data
(63) Continuation of application No. PCT/JP2020/016054, filed on Apr. 9, 2020.

(30) Foreign Application Priority Data
Jun. 26, 2019 (JP) 2019-118969

(51) Int. Cl. C03C 21/00; C03C 4/18; C03C 10/00

(52) U.S. Cl. CPC C03C 21/002; C03C 2204/00; C03C 10/0027; C03C 4/18

(57) ABSTRACT

The present invention relates to a method of producing a chemically strengthened glass, the method including chemically strengthening a lithium aluminosilicate glass having a thickness of t [unit: μm], in which the lithium aluminosilicate glass has a fracture toughness value (K1c) of 0.80 MPa·m′¹² or more, the chemical strengthening is chemical strengthening with a strengthening salt including sodium and having a potassium content of less than 5 mass %, and a chemically strengthened glass to be obtained has a surface compressive stress value (CS₀) of 500-1,000 MPa and has a depth DOL [unit: μm] at which a compressive stress value is zero of 0.06 t to 0.2 t.

### CROSS-REFERENCE TO RELATED APPLICATIONS

This is a bypass continuation of International Patent Application No. PCT/JP2020/016054, filed on Apr. 9, 2020, which claims priority to Japanese Patent Application No. 2019-118969, filed on Jun. 26, 2019. The contents of these applications are hereby incorporated by reference in their entireties.

### TECHNICAL FIELD

The present invention relates to a method of producing a chemically strengthened glass and to chemically strengthened glass.

### BACKGROUND ART

Cover glasses constituted of chemically strengthened glasses are used for the purposes of protecting the display devices of portable telephones, smartphones, tablet devices, etc. and enhancing the appearance attractiveness.

In chemically strengthened glasses, there is a tendency that the greater the surface compressive stress (value) (CS₀) or the depth of compressive stress layer (DOL), the higher the strength. Meanwhile, internal tensile stress (value) (CT) generates within the glass so as to be balanced with the compressive stress of the glass surface layer and, hence, the greater the CS₀ or DOL, the higher the CT. In glasses having a high CT, there is a heightened possibility that, upon reception of damage, the glasses might break into a tremendous number of fragments and scatter the fragments.

Patent Document 1 describes a feature in which surface compressive stress can be increased while inhibiting internal tensile stress from increasing, by performing two-stage chemical strengthening to thereby form a stress profile represented by a broken line. Specifically, Patent Document 1 proposes, for example, a method in which a KNO₃NaNO₃ salt mixture having a low K concentration is used in first-stage chemical strengthening and a KNO₃/NaNO₃ salt mixture having a high K concentration is used in second-stage chemical strengthening.

Patent Document 2 discloses a lithium aluminosilicate glass having relatively high surface compressive stress and a relatively large depth of compressive stress layer, obtained by two-stage chemical strengthening. The lithium aluminosilicate glass can have increased values of CS₀ and DOL while being inhibited from increasing in CT, owing to a two-stage chemical strengthening treatment in which a sodium salt is used in a first-stage chemical strengthening treatment and a potassium salt is used in a second-stage chemical strengthening treatment.

### CITATION LIST

### Patent Literature

Patent Document 1: U.S. Patent Application Publication No. 2015/0259244

Patent Document 2: JP-T-2013-520388 (The term “JP-T” as used herein means a published Japanese translation of a PCT patent application.)

### SUMMARY OF INVENTION

### Technical Problems

However, the two-stage chemical strengthening necessitates complicated treatments and has a problem regarding production efficiency. In addition, the generation of compressive stress in a glass surface layer by chemical strengthening results in tensile stress in an inner portion of the glass as stated above, and if the tensile stress exceeds a threshold value (sometimes called “CT limit”), this glass, upon reception of damage, may break into a tremendously increased number of fragments.

The present inventors have discovered that a chemically strengthened glass, even when higher compressive stress has been introduced thereinto, can be inhibited from fracturing explosively upon reception of damage, by using a glass having high fracture toughness as a base glass for the chemically strengthened glass. That is, the present inventors have discovered that the CT limit can be heightened by increasing the fracture toughness value of the base glass for the chemically strengthened glass. By using a lithium aluminosilicate glass as a base material for a chemically strengthened glass, the base material can be made to have a greatly improved fracture toughness value. However, there are cases where lithium aluminosilicate glasses, upon chemical strengthening, come to have considerably reduced weatherability as compared with before the chemical strengthening.

Accordingly, the present invention provides a chemically strengthened glass which is less apt to fracture upon reception of damage and is excellent in terms of strength and weatherability and a method of producing the chemically strengthened glass.

### Solution to the Problems

With respect to those problems, the present inventors have discovered that a main cause of the decrease in weatherability due to the chemical strengthening of a lithium aluminosilicate glass is a precipitate formed by a reaction between potassium ions introduced into the glass surface by chemical strengthening with a strengthening salt including potassium and a component in air. The present inventors have further discovered that a chemically strengthened glass which is inhibited from fracturing upon reception of damage and is excellent in terms of strength and weatherability is obtained by subjecting a lithium aluminosilicate glass having a fracture toughness value not less than a specific range to chemical strengthening with a strengthening salt including sodium and having a potassium content of less than 5 mass %. The present invention has been completed based on these findings.

The present invention is as follows.

1. A method of producing a chemically strengthened glass, the method including chemically strengthening a lithium aluminosilicate glass having a thickness of t [unit: μm],

in which the lithium aluminosilicate glass has a fracture toughness value (K1c) of 0.80 MPa·m^{1/2} or more,

the chemical strengthening is chemical strengthening with a strengthening salt including sodium and having a potassium content of less than 5 mass %, and

a chemically strengthened glass to be obtained has a surface compressive stress value (CS₀) of 500-1,000 MPa and has a depth DOL [unit: μm] at which a compressive stress value is zero of 0.06 t to 0.2 t.

2. The method of producing a chemically strengthened glass according to 1 above, in which the lithium aluminosilicate glass is a glass ceramic.

3. The method of producing a chemically strengthened glass according to 2 above, in which the glass ceramic includes, in mole percentage on an oxide basis:

40-72% of SiO₂;

0.5-10% of Al₂O₃; and

15-50% of Li₂O.

4. The method of producing a chemically strengthened glass according to 2 or 3 above, in which the glass ceramic has a visible-light transmittance as converted into a value corresponding to a thickness of 0.7 mm of 85% or more

5. The method of producing a chemically strengthened glass according to any one of 2 to 4 above, in which the glass ceramic includes lithium metasilicate crystals.

6. The method of producing a chemically strengthened glass according to 1 above, in which the lithium aluminosilicate glass includes, in mole percentage on an oxide basis:

40-65% of SiO₂;

15-45% of Al₂O₃; and

2-15% of Li₂O.

7. A chemically strengthened glass having a thickness oft [unit: μm],

being a lithium aluminosilicate glass,

having a surface compressive stress value (CS₀) of 500-1,000 MPa, having a compressive stress value (CS₅₀) at a depth of 50 μm from a glass surface of 150-230 MPa,

having a depth DOL [unit: μm] at which a compressive stress value is zero of 0.06 t to 0.2 t, and

having a value of (CS₀×DOL)/K1c [unit: μm/m^{1/2}] of 40,000 to 70,000.

8. The chemically strengthened glass according to 7 above, in which the surface thereof has a concentration of K of 1 mass % or less.

9. A chemically strengthened glass having a thickness oft [unit: μm],

being a lithium aluminosilicate glass,

having a surface compressive stress value (CS₀) of 500-1,000 MPa,

having a compressive stress value (CS₅₀) at a depth of 50 μm from a glass surface of 150-230 MPa, and

having a ratio CT/X of 0.7-1, where CT is an internal compressive stress value [unit: MPa] and X is represented by the following expression:

$$X = √ ( 1 \text{/} 2 a ( 1 - v ) ( t - 2 \times D O L ) ) K 1 c$$

where a=0.11,

v is Poisson's ratio [unit: −]

DOL is a depth [unit: μm] at which a compressive stress value is zero, and

K1c is a fracture toughness value [unit: MPa·m^{1/2}].

10. The chemically strengthened glass according to any one of 7 to 9 above, in which a base glass of the chemically strengthened glass is a glass ceramic having K1c of 0.85 MPa·m^{1/2} or more.

11. The chemically strengthened glass according to 10 above, in which the glass ceramic includes lithium metasilicate crystals.

12. The chemically strengthened glass according 10 or 11 above, in which the glass ceramic includes, in mole percentage on an oxide basis:

40-72% of SiO₂;

0.5-10% of Al₂O₃; and

15-50% of Li₂O, and

includes substantially no K₂O.

13. The chemically strengthened glass according to any one of 7 to 9 above, in which a base glass of the chemically strengthened glass includes, in mole percentage on an oxide basis, 40-65% of Si02, 15-45% of Al₂O₃, and 2-15% of Li₂O, and has K1c of 0.80 MPa·m^{1/2} or more.

### Advantageous Effects of Invention

In the method of the present invention for producing a chemically strengthened glass, a lithium aluminosilicate glass having a fracture toughness value not less than a specific range is chemically strengthened with a strengthening salt including sodium and having a potassium content of less than 5 mass %. Thus, it is possible to efficiently produce a chemically strengthened glass which can be inhibited from fracturing upon reception of damage and is superior in both strength and weatherability to conventional glasses. The chemically strengthened glasses of the present invention are less apt to fracture upon reception of damage and are excellent in terms of strength and weatherability, and are hence suitable for use as cover glasses.

### BRIEF DESCRIPTION OF DRAWINGS

FIG. 1 is a diagram showing a stress profile of a chemically strengthened glass according to one aspect of the present invention.

FIG. 2 is a diagram showing one example of X-ray powder diffraction patterns of glass ceramics.

FIG. 3 is a diagram showing one example of DSC curves of an amorphous glass according to the present invention.

FIG. 4A and FIG. 4B are diagrams showing examples of the results of causing damage to glasses; FIG. 4A is a diagram illustrating the case of a glass having a CT not higher than a CT limit, and FIG. 4B is a diagram illustrating the case of a glass having a CT exceeding a CT limit.

### DESCRIPTION OF EMBODIMENTS

The chemically strengthened glasses of the present invention are described in detail below, but the present invention is not limited to the following embodiments and can be modified at will within the gist of the present invention.

In this description, the term “chemically strengthened glass” means a glass which has undergone a chemical strengthening treatment. The term “glass for chemical strengthening” means a glass which has not undergone a chemical strengthening treatment.

In this description, the glass composition of a glass for chemical strengthening is sometimes called the base composition of a chemically strengthened glass. In chemically strengthened glasses, a compressive stress layer has usually been formed in glass surface portions by ion exchange and, hence, the portions which have not undergone the ion exchange have a glass composition that is identical with the base composition of the chemically strengthened glass. Also in the portions which have undergone the ion exchange, the concentrations of components other than alkali metal oxides basically remain unchanged.

In this description, the composition of each glass is expressed in mole percentage on an oxide basis, and “mol %” is often expressed simply by “%”. Furthermore, symbol “−” indicating a numerical range is used in the sense of including the numerical values set force before and after the “−” as a lower limit value and an upper limit value.

The expression “containing substantially no X” used for a glass composition means that the composition does not contain X except the one from any unavoidable impurity which was contained in a raw material, etc., that is, X has not been incorporated on purpose. The content thereof in the glass composition is, for example, less than 0.1 mol %, except for the case where X is a transition-metal oxide or the like which causes coloration.

In this description, “stress profile” is a pattern showing compressive stress values using the depth from a glass surface as a variable. Negative values of compressive stress mean tensile stress. “Depth of compressive stress layer (DOC)” is a depth at which the compressive stress value (CS) is zero. The term “internal tensile stress value (CT)” means a tensile stress value as measured at a depth which is ½ the glass sheet thickness t.

In general, a stress profile is frequently determined using an optical-waveguide surface stress meter (e.g., FSM-6000, manufactured by Orihara Industrial Co., Ltd.). However, the optical-waveguide surface stress meter, because of the principle of measurement, is usable in stress measurements only when the refractive index decreases from the surface toward the inside. As a result, the stress meter cannot be used for measuring the compressive stress of a glass obtained by chemically strengthening a lithium aluminosilicate glass with a sodium salt. In this description, a stress profile hence is determined using a scattered-light photoelastic stress meter (e.g., SLP-1000, manufactured by Orihara Industrial Co., Ltd.). With a scattered-light photoelastic stress meter, stress values can be measured regardless of a refractive-index distribution of the inner portion of the glass. However, the scattered-light photoelastic stress meter is apt to be affected by light scattered by the surface and it is hence difficult to precisely measure stress values of a portion near the glass surface. With respect to a surface-layer portion extending to a depth of 10 μm from the surface, stress values can be estimated from measured values for a deeper portion by extrapolation using a complementary error function.

### Chemically Strengthened Glasses

A chemically strengthened glass according to this aspect is a chemically strengthened glass having a thickness oft [unit: μm], the chemically strengthened glass being a lithium aluminosilicate glass and having a surface compressive stress value (CS₀) of 500-1,000 MPa, a compressive stress value (CS₅₀) at a depth of 50 μm from a glass surface of 150-230 MPa, and a depth DOL [unit: μm] at which the compressive stress value is zero of 0.06 t to 0.2 t, and having a value of (CS₀×DOL)/K1c [unit: μm/m^{1/2}] of 40,000 to 70,000.

K1c is fracture toughness value [unit: μm/m^{1/2}].

This chemically strengthened glass preferably has a glass surface having a K concentration of 1 mass % or less.

Alternatively, the chemically strengthened glass according to this aspect is a chemically strengthened glass having a thickness oft [unit: μm], the chemically strengthened glass being a lithium aluminosilicate glass and having a surface compressive stress value (CS₀) of 500-1,000 MPa, a compressive stress value (CS₅₀) at a depth of 50 μm from a glass surface of 150-230 MPa, and a ratio CT/X of 0.7-1, where CT is internal compressive stress value [unit: MPa] and X is represented by the following expression:

$$X = √ ( 1 \text{/} 2 a ( 1 - v ) ( t - 2 \times D O L ) ) K 1 c$$

where symbol a is 0.11 and v is Poisson's ratio.

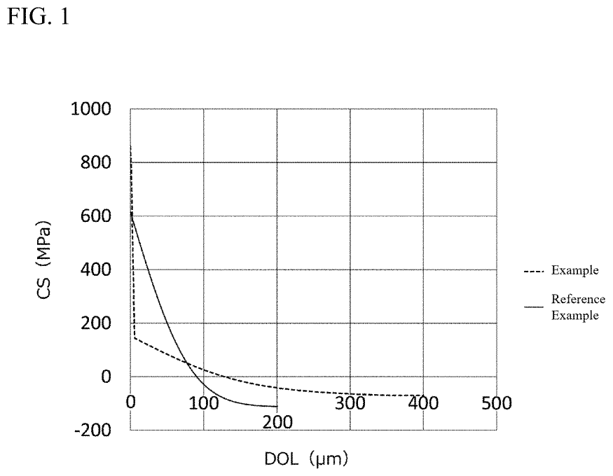

FIG. 1 is a diagram showing a stress profile of a chemically strengthened glass according to one aspect of the present invention. In FIG. 1, “Example” is a stress profile of the chemically strengthened glass (chemically strengthened glass SG5 which will be described later) according to one aspect of the present invention. “Reference Example” is a stress profile of a chemically strengthened glass obtained by subjecting glass G21 which will be described later to two-stage chemical strengthening without crystallization.

If a glass sheet deflects upon reception of impact and the deflection amount is large, then high tensile stress is imposed on a glass surface, resulting in a fracture of the glass. In this description, this fracture is called “bending-mode glass fracture”.

Since the chemically strengthened glasses of the present invention are higher in the outermost-surface CS of the glass than the chemically strengthened glass of Reference Example as shown in FIG. 1, the chemically strengthened glasses of the present invention are inhibited from suffering bending-mode glass fracture. Furthermore, since the chemically strengthened glasses of the present invention have a CS₅₀ of 150-230 MPa, the chemically strengthened glasses can be inhibited from having a large internal stress area (St). As a result, the chemically strengthened glasses can have a reduced CT and be inhibited from fracturing upon reception of damage. St is a value obtained from a stress profile by integrating tensile stress values for a region extending from the DOL to the sheet-thickness center t/2.

The thickness (t) of the chemically strengthened glass of the present invention is, for example, 2 mm or less, preferably 1.5 mm or less, still more preferably 1 mm or less, yet still more preferably 0.9 mm or less, especially preferably 0.8 mm or less, most preferably 0.7 mm or less. Meanwhile, from the standpoint of obtaining sufficient strength, the thickness thereof is, for example, 0.1 mm or more, preferably 0.2 mm or more, more preferably 0.4 mm or more, still more preferably 0.5 mm or more, especially preferably 0.6 mm or more.

The chemically strengthened glasses of the present invention are each produced by subjecting a lithium aluminosilicate glass to an ion exchange treatment. As compared with sodium aluminosilicate glasses which have conventionally been extensively used as glasses for chemical strengthening, lithium aluminosilicate glasses tend to have a large fracture toughness value and be less apt to break even when damaged. In addition, lithium aluminosilicate glasses tend to be high in CT limit, which will be described later, and be less apt to fracture vigorously even when having an increased glass-surface compressive stress value.

The chemically strengthened glasses of the present invention each have a CS₀ of 500 MPa or more, preferably 550 MPa or more, more preferably 600 MPa or more. Since the CS₀ thereof is 500 MPa or more, tensile stress caused by dropping is countervailed and this renders the glass less apt to fracture and can inhibit the glass from suffering a bending-mode fracture. In addition, since the sum of compressive stress in a glass surface layer is constant, too high a CS₀ value results in a decrease in CS₅₀, which is the CS of an inner portion of the glass. Consequently, from the standpoint of preventing the glass from fracturing upon reception of impact, the CS₀ thereof is 1,000 MPa or less, preferably 800 MPa or less, more preferably 750 MPa or less.

The chemically strengthened glasses of the present invention each have a CS₅₀ of 150 MPa or more, preferably 160 MPa or more, more preferably 170 MPa or more. Since the CS₅₀ thereof is 150 MPa or more, this glass can have improved strength. However, too high a CS₅₀ results in an increase in internal tensile stress CT to make the glass prone to fracture. From the standpoint of inhibiting the glass from fracturing (fracturing explosively upon reception of damage), the CS₅₀ thereof is 230 MPa or less, preferably 220 MPa or less, more preferably 210 MPa or less.

The depth (DOL) at which the compressive stress value is 0 is 0.2 t or less, preferably 0.19 t or less, more preferably 0.18 t or less, because too large values thereof with respect to the thickness t [unit: μm] result in an increase in CT. Specifically, in cases when the sheet thickness t is, for example, 0.8 mm, the DOL is preferably 160 μm or less. Meanwhile, from the standpoint of improving the strength, the DOL is 0.06 t or more, preferably 0.08 t or more, more preferably 0.10 t or more, still more preferably 0.12 t or more.

In cases when compressive stress is generated in a glass surface layer by chemical strengthening, CT is generated in an inner portion of the glass and, if the CT exceeds a CT limit, this glass, upon reception of damage, breaks into a tremendous number of fragments.

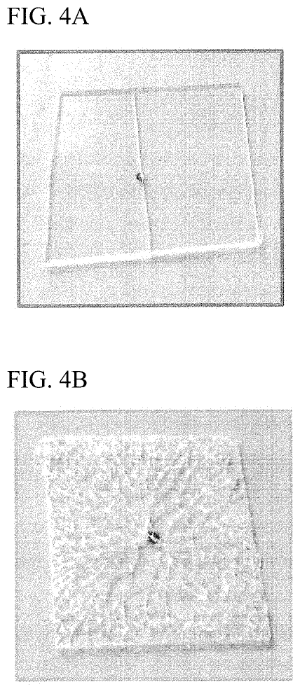

In FIG. 4A and FIG. 4B are shown examples of the results of causing damage, using a Vickers tester, to chemically strengthened glasses by the method which will be described later in Examples. FIG. 4A is a diagram illustrating the case of a glass having a CT not higher than a CT limit, and FIG. 4B is a diagram illustrating the case of a glass having a CT exceeding a CT limit. Since the sum of compressive stress in a surface layer is determined by the CT limit, a glass can be inhibited from fracturing upon reception of damage by regulating the sum of surface-layer compressive stress to a value within a certain range to lower the CT or by making the glass have high fracture toughness to heighten the CT limit.

The chemically strengthened glass of the present invention has a value of (CS₀×DOL)/K1c [unit: μm/m^{1/2}] of 40,000 to 70,000, preferably 42,000 to 58,000, more preferably 44,000 to 55,000. Since (CS₀×DOL)/K1c is within that range, the glass has an improved surface-layer CS to inhibit a bending-mode fracture, has improved drop strength, has a limited value of St and a smaller value of CT and can hence be inhibited from fracturing upon reception of damage.

From the standpoint of inhibiting fracture while improving the drop strength, the value of (t−2×DOL)×CT/2 [unit: μm·MPa] is preferably 20,000-30,000. The value of (t−2×DOL)×CT/2 [unit: μm·MPa] is more preferably 25,000 or less. (t−2×DOL)×CT/2 is approximated to the integral St of tensile stress.

A glass having a large fracture toughness value has a high CT limit and is hence less apt to fracture vigorously even when having a high surface compressive stress introduced thereinto by chemical strengthening. From the standpoint of inhibiting the chemically strengthened glass of the present invention from fracturing upon reception of damage, the base glass for the chemically strengthened glass has a fracture toughness value of preferably 0.80 MPa·m^{1/2} or more, more preferably 0.85 MPa·m^{1/2} or more, still more preferably 0.90 MPa·m^{1/2} or more. The fracture toughness value thereof is usually 2.0 MPa·m^{1/2} or less, typically 1.5 MPa·m^{1/2} or less.

Fracture toughness value can be measured, for example, using a DCDC method (Acta metall. mater, Vol. 43, pp. 3453-3458, 1995). An easy method for evaluating fracture toughness value is an indentation method. Examples of methods for regulating the fracture toughness to a value within that range include a method in which the degree of crystallization, fictive temperature, or the like is regulated by regulating crystallization conditions (time period of heat treatment and temperature therefor) for producing a glass ceramic, glass composition, cooling rate, etc. Specifically, in the case of a glass ceramic, for example, the degree of crystallization of the glass ceramic, which will be described later, is regulated to preferably 15% or more, more preferably 18% or more, still more preferably 20% or more. From the standpoint of ensuring a transmittance, the degree of crystallization of the glass ceramic is preferably 60% or less, more preferably 55% or less, still more preferably 50% or less, especially preferably 40% or less.

The present inventors have experimentally discovered that the CT limit value is approximately equal to the value of X represented by the following expression:

$$X = √ ( 1 \text{/} 2 a ( 1 - v ) ( t - 2 \times D O L ) ) K 1 c$$

where a=0.11 and v is Poisson's ratio.

That is, in cases when the ratio between CT and X, CT/X, is 1 or less, this glass is less apt to fracture vigorously. Hence, by regulating CT/X to 0.7-1, the CS can be heightened while inhibiting fracture.

From the standpoint of preventing fracture, CT/X is preferably 0.95 or less, more preferably 0.9 or less.

There have been cases where a chemically strengthened glass obtained by subjecting a lithium aluminosilicate glass to a two-stage ion exchange treatment has lower weatherability than before the chemical strengthening treatment. The present inventors made investigations on such chemically strengthened glasses having reduced weatherability and, as a result, have discovered that a potassium-containing precipitate has been yielded in the glass surfaces. This precipitate is presumed to have been yielded by a reaction between potassium ions, which are present in a large amount in the glass surfaces, and a component in air. On embodiment of the chemically strengthened glasses of the present invention has a base composition in which the ratio of the alkali content to the content of alumina is high, and is especially prone to decrease in weatherability.

A glass surface of the chemically strengthened glass of the present invention has a low K concentration, and this chemically strengthened glass hence is prevented from chemically reacting with components in the air and shows excellent weatherability. In the chemically strengthened glass of the present invention, the K concentration in the glass surface is 1 mass % or less, more preferably 0.8 mass % or less, still more preferably 0.6 mass % or less.

In this description, the term “K concentration in a glass surface” means the concentration of K in a portion ranging from the glass surface to a depth of 1 μm. A lower limit of the K concentration in the glass surface is usually at least 1/1,000 the original K concentration (mass %) in the glass composition. The term “original K concentration of the glass composition” means the K concentration of the glass which has not been chemically strengthened. The K concentration of the glass surface can be determined with an EPMA (electron probe micro analyzer).

The weatherability of a chemically strengthened glass can be evaluated through a weatherability test. The chemically strengthened glasses of the present invention have a difference in haze between before and after 120-hour standing at 80% humidity and 80° C. of preferably 5% or less (that is, |(haze [%] after the test)−(haze [%] before the test)|≤5), more preferably 4% or less, still more preferably 3% or less. Haze is measured using a hazeometer and an illuminant C in accordance with JIS K7136 (2000).

The chemically strengthened glasses of the present invention may have any of shapes other than sheet shapes, in accordance with products, uses, etc. to which the glasses are applied. The glass sheet may have, for example, a trimmed shape in which the periphery has different thicknesses. Configurations of the glass sheet are not limited to these. For example, the two main surfaces may not be parallel with each other, or some or all of one or each of the two main surfaces may be a curved surface. More specifically, the glass sheet may be, for example, a flat glass sheet having no warpage or may be a curved glass sheet having curved surfaces.

The chemically strengthened glasses of the present invention can be used as cover glasses for mobile electronic appliances such as portable telephones, smartphones, portable digital assistants (PDAs), and tablet devices. The chemically strengthened glasses of the present invention are useful also as the cover glasses of electronic appliances not intended to be carried, such as televisions (TVs), personal computers (PCs), and touch panels. Furthermore, the chemically strengthened glasses of the present invention are useful as building materials, e.g., window glasses, table tops, interior trims for motor vehicles, airplanes, etc., and cover glasses for these.

Since the chemically strengthened glasses of the present invention can have a shape other than the flat sheet shape by performing bending or shaping before or after the chemical strengthening, the chemically strengthened glasses are useful also in applications such as housings having a curved shape.

### Lithium Aluminosilicate Glass

The chemically strengthened glass of the present invention is a lithium aluminosilicate glass. So long as the lithium aluminosilicate glass is a glass including SiO₂, Al₂O₃, and Li₂O, this glass is not particularly limited in its form. Examples thereof include a glass ceramic and an amorphous glass. The glass ceramic and the amorphous glass are described below.

### Glass Ceramic

In the case where the lithium aluminosilicate glass according to the present invention is a glass ceramic, a preferred embodiment thereof includes, in mole percentage on an oxide basis:

40-72% of SiO₂;

0.5-10% of Al₂O₃; and

15-50% of Li₂O.

This glass ceramic preferably includes at least one kind of crystals selected from among lithium silicate crystals, lithium aluminosilicate crystals, and lithium phosphate crystals. The lithium silicate crystals are more preferably lithium metasilicate crystals. The lithium aluminosilicate crystals are preferably petalite crystals or β-spodumene crystals. The lithium phosphate crystals are preferably lithium orthophosphate crystals.

From the standpoint of enhancing the transparency, glass ceramic containing lithium metasilicate crystals is more preferable.

The glass ceramic is obtained by heat-treating an amorphous glass, which will be explained later, to crystallize the glass. The glass composition of the glass ceramic is the same as the composition of the amorphous glass which has not undergone the crystallization, and will hence be explained in the section Amorphous Glass.

The glass ceramic preferably has a visible-light transmittance (transmittance for total visible light including diffused transmitted light) of 85% or more as converted into a value corresponding to a thickness of 0.7 mm. When the glass ceramic having such visible-light transmittance is used as a cover glass of a portable display, images on a screen of the display is highly visible. The visible-light transmittance thereof is more preferably 88% or more, still more preferably 90% or more. The higher the visible-light transmittance, the more the glass ceramic is preferred. Usually, however, the visible-light transmittance thereof is 93% or less. The visible-light transmittances of ordinary amorphous glasses are about 90% or more.

In the case where the thickness of the glass ceramic is not 0.7 mm, the transmittance of the glass ceramic as converted into a value corresponding to a thickness of 0.7 mm can be calculated from a measured transmittance using Lambert-Beer's law.

In the case of a glass having a sheet thickness t larger than 0.7 mm, this glass may be polished, etched, or otherwise processed to regulate the sheet thickness to 0.7 mm to conduct an actual measurement of the transmittance.

The haze of the glass ceramic, as converted into a value corresponding to a thickness of 0.7 mm, is preferably 1.0% or less, more preferably 0.4% or less, still more preferably 0.3% or less, especially preferably 0.2% or less, most preferably 0.15% or less. The lower the haze, the more the glass ceramic is preferred. However, in cases when the degree of crystallization is lowered or the crystal-grain diameter is reduced in order to reduce the haze, this results in a decrease in mechanical strength. From the standpoint of attaining increased mechanical strength, the haze of the glass ceramic, as converted into a value corresponding to a thickness of 0.7 mm, is preferably 0.02% or more, more preferably 0.03% or more. Values of haze are measured in accordance with JIS K7136 (2000).

In cases when a glass ceramic having a sheet thickness oft [mm] has a total visible-light transmittance of 100×T [%] and a haze of 100×H [%], then Lambert-Beer's law can be used to express T by T=(1−R)2×exp(−αt) using a constant α. This constant α can be used to express the haze as follows.

$$dH \text{/} dt \text{∼} exp ( - α t ) \times ( 1 - H )$$

That is, since it can be thought that as the sheet thickness increases, the haze increases in proportion to an internal linear transmittance, the haze H_{0.7} of the glass having a thickness of 0.7 mm can be determined using the following expression.

$${H}_{0.7} = 100 \times [ 1 - {( 1 - H )}^{\{ ( ( 1 - R ) 2 - T 0.7 ) / ( ( 1 - R ) 2 - T ) \}} ] [ \% ]$$

Meanwhile, in the case of a glass having a sheet thickness t larger than 0.7 mm, this glass may be polished, etched, or otherwise processed to regulate the sheet thickness to 0.7 mm to conduct an actual measurement of the haze.

In the case where a strengthened glass obtained by strengthening a glass ceramic is to be used as the cover glass of a portable display, it is preferable that this strengthened glass has a high-grade texture different from the texture of plastics. From the standpoint of attaining this quality, this glass ceramic has a refractive index at 590 nm wavelength of preferably 1.52 or more, more preferably 1.55 or more, still more preferably 1.57 or more.

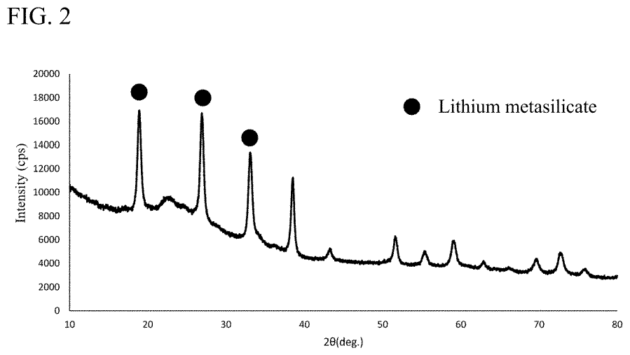

The glass ceramic is preferably a glass ceramic containing lithium metasilicate crystals. Lithium metasilicate crystals are crystals represented by Li₂SiO₃ and generally giving an X-ray powder diffraction spectrum which has diffraction peaks at Bragg angles (2θ) of 26.98°±0.2°, 18.88°±0.2°, and 33.05°±0.2°. FIG. 2 shows one example of X-ray diffraction spectra of glass ceramic, and diffraction peaks assigned to lithium metasilicate crystals are observed therein.

Glass ceramics containing lithium metasilicate crystals have high fracture toughness values as compared with general amorphous glasses and are less apt to fracture vigorously even after high compressive stress is provided therein by chemical strengthening. There are cases where amorphous glasses in which lithium metasilicate crystals can be precipitated undergo precipitation of lithium disilicate therein depending on heat treatment conditions, etc. The lithium disilicate is represented by Li₂Si₂O₅ and is crystals generally giving an X-ray powder diffraction spectrum which has diffraction peaks at Bragg angles (2θ) of 24.89°±0.2°, 23.85°±0.2°, and 24.40°±0.2°.

In the case where the glass ceramic contains lithium disilicate crystals, the lithium disilicate crystals preferably have a crystal grain diameter, as determined from the width of an

X-ray diffraction peak using the Scherrer equation, of 45 nm or less, because transparency is easy to obtain. The crystal grain diameter thereof is more preferably 40 nm or less. Although the Scherrer equation includes a shape factor, the factor in this case may be represented by the dimensionless number of 0.9 (that is, the crystal grains are assumed to be spherical).

In cases when the glass ceramic containing lithium metasilicate crystals further contains lithium disilicate crystals, this glass ceramic is prone to have reduced transparency. It is hence preferable that the glass ceramic contains no lithium disilicate. The expression “containing no lithium disilicate” means that no diffraction peaks assigned to lithium disilicate crystals are detected in the X-ray diffraction spectrum.

The degree of crystallization of the glass ceramic is preferably 5% or more, more preferably 10% or more, still more preferably 15% or more, especially preferably 20% or more, from the standpoint of enhancing the mechanical strength. From the standpoint of heightening the transparency, the degree of crystallization thereof is preferably 70% or less, more preferably 60% or less, especially preferably 50% or less. Low degrees of crystallization are advantageous also in that this glass ceramic is easy to, for example, bend with heating.

The degree of crystallization can be calculated from X-ray diffraction intensity by the Rietveld method. The Rietveld method is described in The Crystallographic Society of Japan “Crystal Analysis Handbook” editorial board, ed., “Crystal Analysis Handbook”, Kyoritsu Shuppan, pp. 492-499, 1999.

The precipitated crystals in the glass ceramic have an average grain diameter of preferably 80 nm or less, more preferably 60 nm or less, still more preferably 50 nm or less, especially preferably 40 nm or less, most preferably 30 nm or less. The average grain diameter of the precipitated crystals is determined from images obtained with a transmission electron microscope (TEM). The average grain diameter of the precipitated crystals can be estimated from images obtained with a scanning electron microscope (SEM).

The glass ceramic has an average coefficient of thermal expansion at 50-350° C. of preferably 90×10⁻7° C. or more, more preferably 100×10⁻⁷/° C. or more, still more preferably 110×10⁻⁷/° C. or more, especially preferably 120×10⁻⁷/° C. or more, most preferably 130×10⁻⁷/° C. or more.

In case where the coefficient of thermal expansion thereof is too high, there is a possibility that the glass ceramic might crack due to a difference in thermal expansion coefficient during chemical strengthening. Because of this, the average coefficient of thermal expansion thereof is preferably 160×10⁻⁷/° C. or less, more preferably 150x 10⁻7° C. or less, still more preferably 140×10⁻⁷/° C. or less.

The glass ceramic has a high hardness because it contains crystals. The glass ceramic hence is less apt to receive scratches and has excellent wear resistance. From the standpoint of enhancing the wear resistance, the glass ceramic has a Vickers hardness of preferably 600 or more, more preferably 700 or more, still more preferably 730 or more, especially preferably 750 or more, most preferably 780 or more.

Too high hardnesses make the glass difficult to process. The Vickers hardness of the glass ceramic hence is preferably 1,100 or less, more preferably 1,050 or less, still more preferably 1,000 or less.

The glass ceramic has a Young's modulus of preferably 85 GPa or more, more preferably 90 GPa or more, still more preferably 95 GPa or more, especially preferably 100 GPa or more, from the standpoint of inhibiting the glass from being warped by chemical strengthening. There are cases where the glass ceramic is polished before being used. From the standpoint of facilitating the polishing, the Young's modulus thereof is preferably 130 GPa or less, more preferably 125 GPa or less, still more preferably 120 GPa or less.

The glass ceramic has a fracture toughness value of preferably 0.8 MPa·m^{1/2} or more, more preferably 0.85 MPa·m^{1/2} or more, still more preferably 0.9 MPa·m^{1/2} or more. This is because the chemically strengthened glass obtained by chemically strengthening the glass ceramic having such a fracture toughness value is less apt to scatter fragments upon breakage.

In the case where the lithium aluminosilicate glass in the present invention is a glass ceramic, a preferred embodiment thereof includes, in mole percentage on an oxide basis, 40-72% SiO₂, 0.5-10% Al₂O₃, 15-50% Li₂O, 0-4% P₂O₅, 0-6% ZrO₂, 0-7% Na₂O, and 0-5% K₂O. That is, it is preferable that an amorphous glass (hereinafter sometimes referred to as “crystallizable amorphous glass”) including, in mole percentage on an oxide basis, 40-72% SiO₂, 0.5-10% Al₂O₃, 15-50% Li₂O, 0-4% P₂O₅, 0-6% ZrO₂, 0-7% Na2O, and 0-5% K₂O is heat-treated and crystallized.

### Crystallizable Amorphous Glass

A preferred embodiment of the crystallizable amorphous glass in the present invention includes, in mole percentage on an oxide basis, 40-72% SiO₂, 0.5-10% Al₂O₃, 15-50% Li₂O, 0-4% P₂O₅, 0-6% ZrO₂, 0-7% Na₂O, and 0-5% K₂O.

This glass composition is explained below.

In the crystallizable amorphous glass, SiO₂ is a component which forms network structure of the glass. SiO₂ is also a component which heightens the chemical durability and is a constituent component of lithium silicate crystals and lithium aluminosilicate crystals. The content of SiO₂ is preferably 40% or more. The content of SiO₂ is more preferably 42% or more, still more preferably 45% or more. From the standpoint of enabling sufficiently high stress to be generated by chemical strengthening, the content of SiO₂ is preferably 72% or less. From the standpoint of precipitating lithium metasilicate crystals, the content of SiO₂ is preferably 60% or less, more preferably 58% or less, still more preferably 55% or less.

Al₂O₃ is a component which enhances the surface compressive stress to be generated by chemical strengthening, and is essential. The content of Al₂O₃ is preferably 0.5% or more. From the standpoint of enhancing the stress to be generated by chemical strengthening, the content of Al₂O₃ is more preferably 1% or more, still more preferably 2% or more. Meanwhile, from the standpoint of obtaining a glass ceramic having a reduced haze, the content of Al₂O₃ is preferably 10% or less, more preferably 8% or less, still more preferably 6% or less.

Li₂O is a component which generates surface compressive stress through ion exchange. Li₂O is a constituent component of lithium silicate crystals, lithium aluminosilicate crystals, and lithium phosphate crystals, and is essential. The content of Li₂O is preferably 15% or more, more preferably 20% or more, still more preferably 25% or more. Meanwhile, from the standpoint of making the glass retain chemical durability, the content of Li₂O is preferably 50% or less, more preferably 45% or less, still more preferably 40% or less.

Na₂O is a component which improves the meltability of the glass. Although Na₂O is not essential, the content of Na₂O is preferably 0.5% or more, more preferably 1% or more, especially preferably 2% or more. In case where Na2O is contained in too large an amount, lithium metasilicate crystals are less apt to precipitate or chemical strengthening properties are decreased. Consequently, the content of Na₂O is preferably 7% or less, more preferably 6% or less, still more preferably 5% or less.

K₂O is a component which lowers the melting temperature of the glass like Na₂O, and may be contained. The content of K₂O, when it is contained, is preferably 0.5% or more, more preferably 1% or more, still more preferably 1.5% or more, especially preferably 2% or more. In case where K₂O is contained in too large an amount, chemical strengthening properties are decreased. Consequently, the content of K₂O is preferably 5% or less, more preferably 4% or less, still more preferably 3% or less, especially preferably 2% or less.

The total content of Na₂O and K₂O, Na₂O+K₂O, is preferably 0.5% or more, more preferably 1% or more. Meanwhile, Na₂O+K₂O is preferably 7% or less, more preferably 6% or less, still more preferably 5% or less.

The mol % ratio between Li₂O and SiO₂, Li₂O/SiO₂, is preferably 0.4 or more, more preferably 0.45 or more, still more preferably 0.5 or more. Meanwhile, Li₂O/SiO₂ is preferably 0.85 or less, more preferably 0.80 or less, still more preferably 0.75 or less. Such values of Li₂O/SiO₂ render lithium metasilicate crystals apt to precipitate in heat-treating, making it easy to obtain a highly transparent glass ceramic.

The mol % ratio between Li₂O and Na₂O, Li₂O/Na₂O, is preferably 4 or more, more preferably 8 or more, still more preferably 12 or more. Meanwhile, Li₂O/Na₂O is preferably 30 or less, more preferably 28 or less, still more preferably 25 or less. Such values of Li₂O/Na₂O make it easy to obtain a stress profile indicating both a sufficient compressive stress generated by chemical strengthening and relaxation of the surface stress.

P₂O₅, although not essential in the case of a glass ceramic containing lithium silicate or lithium aluminosilicate, has an effect of promoting phase separation in the glass to accelerate crystallization and may be contained. P₂O₅ is an essential component in the case of a glass ceramic containing lithium phosphate crystals. The content P₂O₅, when it is contained, is preferably 0.5% or more, more preferably 1% or more, still more preferably 1.5% or more. Meanwhile, in case where the content of P₂O₅ is too high, the glass not only is prone to undergo phase separation during melting but also has considerably reduced acid resistance. The content of P₂O₅ is preferably 5% or less, more preferably 4% or less, still more preferably 3% or less.

ZrO₂ is a component which can constitute crystal nuclei in a crystallization treatment, and may be contained. The content of ZrO₂ is preferably 1% or more, more preferably 2% or more, still more preferably 2.5% or more, especially preferably 3% or more. Meanwhile, from the standpoint of inhibiting devitrification during melting, the content of ZrO₂ is preferably 6% or less, more preferably 5.5% or less, still more preferably 5% or less.

TiO₂ is a component which can constitute crystal nuclei in a crystallization treatment, and may be contained. Although TiO₂ is not essential, the content thereof, when it is contained, is preferably 0.5% or more, more preferably 1% or more, still more preferably 2% or more, especially preferably 3% or more, most preferably 4% or more. Meanwhile, from the standpoint of inhibiting devitrification during melting, the content of TiO₂ is preferably 10% or less, more preferably 8% or less, still more preferably 6% or less.

SnO₂ serves to accelerate the formation of crystal nuclei and may be contained. Although SnO₂ is not essential, the content thereof, when it is contained, is preferably 0.5% or more, more preferably 1% or more, still more preferably 1.5% or more, especially preferably 2% or more. Meanwhile, from the standpoint of inhibiting devitrification during melting, the content of SnO₂ is preferably 6% or less, more preferably 5% or less, still more preferably 4% or less, especially preferably 3% or less.

Y₂O₃ is a component which renders the chemically strengthened glass less apt to scatter fragments upon fracture, and may be contained. The content of Y₂O₃ is preferably 1% or more, more preferably 1.5% or more, still more preferably 2% or more, especially preferably 2.5% or more, exceedingly preferably 3% or more. Meanwhile, from the standpoint of inhibiting devitrification during melting, the content of Y₂O₃ is preferably 5% or less, more preferably 4% or less.

B₂O₃, although not essential, is a component which improves chipping resistance of the glass for chemical strengthening or of the chemically strengthened glass and which improves the meltability, and may be contained. The content of B₂O₃, when it is contained, is preferably 0.5% or more, more preferably 1% or more, still more preferably 2% or more, from the standpoint of improving the meltability. Meanwhile, in case where the content of B₂O₃ exceeds 5%, striae are prone to occur during melting, resulting in a decrease in the quality of the glass for chemical strengthening. The content of B₂O₃ is hence preferably 5% or less. The content of B₂O₃ is more preferably 4% or less, still more preferably 3% or less, especially preferably 2% or less.

BaO, SrO, MgO, CaO, and ZnO are components which improve the meltability of the glass, and may be contained. In the case where one or more of these components are contained, the total content of BaO, SrO, MgO, CaO, and ZnO, BaO+SrO+MgO+CaO+ZnO, is preferably 0.5% or more, more preferably 1% or more, still more preferably 1.5% or more, especially preferably 2% or more. Meanwhile, the content BaO+SrO+MgO+CaO+ZnO is preferably 8% or less, more preferably 6% or less, still more preferably 5% or less, especially preferably 4% or less, because too high a content thereof results in a decrease in ion exchange rate.

BaO, SrO, and ZnO, among those components, may be incorporated in order to heighten the refractive index of the residual glass to a value close to that of the precipitated crystal phase and thereby improve the transmittance of the glass ceramic and lower the haze thereof. In this case, the total content thereof, BaO+SrO+ZnO, is preferably 0.3% or more, more preferably 0.5% or more, still more preferably 0.7% or more, especially preferably 1% or more. Meanwhile, these components sometimes lower the rate of ion exchange. From the standpoint of improving the chemical strengthening properties, BaO+SrO+ZnO is preferably 2.5% or less, more preferably 2% or less, still more preferably 1.7% or less, especially preferably 1.5% or less.

CeO₂ may be contained. CeO₂ has the effect of oxidizing the glass and sometimes inhibits coloring. The content of CeO₂, when it is contained, is preferably 0.03% or more, more preferably 0.05% or more, still more preferably 0.07% or more. In the case of using CeO₂ as an oxidizing agent, the content of CeO₂ is preferably 1.5% or less, more preferably 1.0% or less, from the standpoint of heightening the transparency.

In cases when the strengthened glass is to be used in a colored state, a coloring component may be added so long as the addition thereof does not inhibit attaining the desired chemical strengthening properties. Suitable examples of the coloring component include Co₃O₄, MnO₂, Fe₂O₃, NiO, CuO, Cr₂O₃, V₂O₅, Bi₂O₃, SeO₂, Er₂O₃, and Nd₂O₃.

The content of such coloring components is preferably up to 1% in total. In the case where the glass is desired to have a higher visible-light transmittance, it is preferable to substantially contain none of these components.

SO₃, a chloride, a fluoride, etc. may be suitably contained as a refining agent or the like for glass melting. It is preferable that no As₂O₃ is contained. In cases when Sb₂O₃ is contained, the content thereof is preferably 0.3% or less, more preferably 0.1% or less. It is most preferable that Sb₂O₃ is not contained.

### High-Toughness Amorphous Glass

The lithium aluminosilicate glass in the present invention may be a high-toughness amorphous glass. Examples of the high-toughness amorphous glass include a glass including, in mole percentage on an oxide basis, 40-65% SiO₂, 15-45% Al₂O₃, and 2-15% Li₂O. The high-toughness amorphous glass preferably contains one or more components selected from among Y₂O₃, La₂O₃, Nb₂O₅, Ta₂O₅, and WO₃, in a total amount of 1-15%.

In the high-toughness amorphous glass, SiO2 is a component which forms the network structure of the glass. SiO₂ is also a component which heightens the chemical durability. The content of SiO2 is preferably 40% or more. The content of SiO2 is more preferably 42% or more, still more preferably 45% or more. From the standpoint of enabling sufficiently high stress to be generated by chemical strengthening, the content of SiO₂ is preferably 65% or less, more preferably 60% or less, still more preferably 55% or less.

Al₂O₃ is a component which enhances the surface compressive stress to be generated by chemical strengthening, and is essential. The content of Al₂O₃ is preferably 15% or more. From the standpoint of enhancing the fracture toughness value, the content of Al₂O₃ is more preferably 20% or more, still more preferably 22% or more, especially preferably 25% or more. Meanwhile, from the standpoint of making the glass easy to melt, the content of Al₂O₃ is preferably 45% or less, more preferably 40% or less, still more preferably 35% or less.

Li₂O is a component which generates surface compressive stress through ion exchange, and is essential. The content of Li₂O is preferably 2% or more, more preferably 4% or more, still more preferably 7% or more. Meanwhile, from the standpoint of making the glass retain the chemical durability, the content of Li₂O is preferably 15% or less, more preferably 13% or less, still more preferably 11% or less.

It is preferable, from the standpoint of lowering the devitrification temperature, that the glass of the present invention contains one or more components selected from among Y₂O₃, La₂O₃, Nb₂O₅, Ta₂O₅, and WO₃, in a total amount of 1% or more. The total content thereof is more preferably 2% or more, still more preferably 3% or more.

Y₂O₃, La₂O₃, Nb₂O₅, Ta₂O₅, and WO₃ are cations having high field strengths. The field strength is a value obtained by dividing the valence of the cation by the ionic radius thereof and indicates the intensity of attracting surrounding oxygen ions. Those components improve the oxygen-atom packing density and hence have the effect of improving the Young's modulus and fracture toughness.

In case where the glass has an excessively heightened Young's modulus, this glass is more difficult to process, resulting in a decrease in yield. From the standpoint of improving the Young's modulus to a degree within an appropriate range, the total content of one or more components selected from among Y₂O₃, La₂O₃, Nb₂O₅, Ta₂O₅, and WO₃, is preferably 15% or less. The content thereof is more preferably 13% or less, still more preferably 12% or less, especially preferably 11% or less.

In the glass composition of the present invention, a ratio between the total content of Y₂O₃, La₂O₃, Nb₂O₅, Ta₂O₅, and WO₃, and the content of Al₂O₃, ([Y₂O₃]+[La₂O₃]+[Nb₂O₅]+[Ta₂O₅]+[WO₃])/[Al₂O₃], is preferably 0.2 or more, more preferably 0.25 or more, still more preferably 0.3 or more, from the standpoint of forming a glass structure having a high packing density. From the standpoint of preventing the glass from having an unnecessarily heightened Young's modulus, ([Y₂O₃]+[La₂O₃]+[Nb₂O₅]+[Ta₂O₅]+[WO₃]/[Al₂O₃] is preferably 0.6 or less, more preferably 0.55 or less, still more preferably 0.5 or less.

L₂O₃, Nb₂O₅, Ta₂O₅, and WO₃, although not essential components, considerably affect the brittleness of the glass and may hence be incorporated in order to regulate the properties evaluated by chipping and scratch tests.

Alkali metal oxides such as Li₂O, Na2O, and K₂O (sometimes inclusively referred to as R₂O) each are not essential, but are components which lower the melting temperature of the glass. One or more of these can be contained.

The amorphous glass has a glass transition point Tg of preferably 390° C. or more, more preferably 410° C. or more, still more preferably 420° C. or more. High glass transition points Tg render the glass less apt to undergo stress relaxation during a chemical strengthening treatment, making it easy to obtain high strength. Meanwhile, in case where the glass has too high a Tg, this glass is difficult to form or otherwise process. Consequently, the Tg thereof if preferably 650° C. or less, more preferably 600° C. or less.

The amorphous glass has an average coefficient of thermal expansion at 50-350° C. of preferably 90×10⁻⁷/° C. or more, more preferably 100×10⁻⁷/° C. or more, still more preferably 110×10⁻⁷/° C. or more. Meanwhile, in case where the amorphous glass has too high a coefficient of thermal expansion, this glass is prone to crack during forming. The coefficient of thermal expansion thereof is hence preferably 150×10⁻⁷/° C. or less, more preferably 140×10⁻⁷/° C. or less. If there is a large difference in thermal expansion coefficient between the amorphous glass and lithium metasilicate crystals, cracks due to a difference in thermal expansion are prone to occur during crystallization.

The difference between a glass transition point (Tg_{DSC}) determined from a DSC curve obtained by pulverizing the amorphous glass and examining the pulverized glass with a differential scanning calorimeter and a crystallization peak temperature (Tc) corresponding to a most lower-temperature-side crystallization peak in the DSC curve is expressed by (Tc−Tg). The (Tc−Tg) of the amorphous glass is preferably 80° C. or more, more preferably 85° C. or more, still more preferably 90° C. or more, especially preferably 95° C. or more. Large values of (Tc−Tg) render the glass ceramic easy to bend or otherwise process with reheating. The (Tc−Tg) thereof is preferably 150° C. or less, more preferably 140° C. or less.

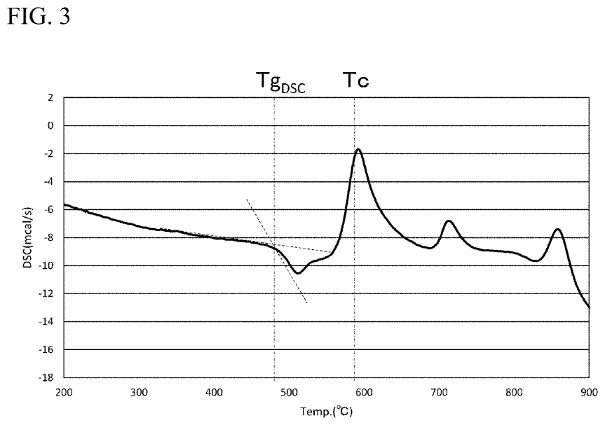

FIG. 3 shows one example of DSC curves of the amorphous glass. There are cases where the Tg_{DSC} shown in FIG. 3 does not coincide with a glass transition point (Tg) determined from a thermal expansion curve. Furthermore, since Tg_{DSC} is determined through an examination of a pulverized glass, large measurement errors are apt to result. However, for evaluating a relationship with crystallization peak temperature, it is appropriate to use the Tg_{DSC} determined through the same DSC examination rather than the Tg determined from a thermal expansion curve.

The amorphous glass has a Young's modulus of preferably 75 GPa or more, more preferably 80 GPa or more, still more preferably 85 GPa or more.

The amorphous glass has a Vickers hardness of preferably 500 or more, more preferably 550 or more.

### Method for Producing Chemically Strengthened Glass

The chemically strengthened glass of the present invention is produced by heat-treating the crystallizable amorphous glass to obtain a glass ceramic and chemically strengthening the obtained glass ceramic. Alternatively, the chemically strengthened glass of the present invention is produced by chemically strengthening the high-toughness amorphous glass described above.

### Production of Amorphous Glass

An amorphous glass can be produced, for example, by the following method. The production method shown below is an example of producing a sheet-shaped, chemically strengthened glass.

Raw materials for glass are mixed so as to obtain a glass having a preferred composition and the mixture is heated and melted in a glass melting furnace. Thereafter, the molten glass is homogenized by bubbling, stirring, addition of a refining agent, etc., formed into a glass sheet having a given thickness by a known forming method, and then annealed. Alternatively, the molten glass may be formed into a block shape, annealed, and then cut into a sheet shape.

Examples of forming methods for producing a sheet-shaped glass include a float process, a pressing process, a fusion process, and a downdraw process. The float process is preferred especially in producing a large glass sheet. Continuous processes other than the float process, such as, for example, a fusion process and a downdraw process, are also preferred.

### Crystallization Treatment

In the case where the lithium aluminosilicate glass in the present invention is a glass ceramic, the glass ceramic is obtained by heat-treating a crystallizable amorphous glass obtained by the procedure described above.

It is preferable that the heat treatment is a two-stage heat treatment in which the crystallizable amorphous glass is heated from room temperature to a first treatment temperature, held at this temperature for a certain time period, and then held at a second treatment temperature, which is higher than the first treatment temperature, for a certain time period.

In the case of performing the two-stage heat treatment, the first treatment temperature is preferably in a temperature range where the glass composition has a high crystal nucleus formation rate, and the second treatment temperature is preferably in a temperature range where the glass composition has a high crystal growth rate. The time period of holding at the first treatment temperature is preferably long so that a sufficient number of crystal nuclei are formed. The formation of a large number of crystal nuclei results in crystals having a reduced size, thereby yielding a highly transparent glass ceramic.

The first treatment temperature is, for example, 450-700° C., and the second treatment temperature is, for example, 600-800° C. The glass is held at the first treatment temperature for 1-6 hours and then held at the second treatment temperature for 1-6 hours.

The glass ceramic obtained by the procedure described above is ground and polished according to need to form a glass-ceramic sheet. In cases when the glass-ceramic sheet is to be cut into a given shape and size or chamfered, it is preferred to perform the cutting or chamfering before a chemical strengthening treatment is given thereto. This is because a compressive stress layer is formed also in the end surfaces by the subsequent chemical strengthening treatment.

### Method of Producing Chemically Strengthened Glass

The chemically strengthened glass of the present invention is produced by chemically strengthening a lithium aluminosilicate glass. Preferred embodiments of the lithium aluminosilicate glass in this production method are the same those described above. The lithium aluminosilicate glass in this production method preferably has the composition described hereinabove.

The lithium aluminosilicate glass can be produced by an ordinary method. For example, raw materials for the components of the glass are mixed and the mixture is heated and melted in a glass melting furnace. Thereafter, the glass is homogenized by a known method, formed into a desired shape, e.g., a glass sheet, and then annealed.

Examples of methods for forming the glass include a float process, a pressing process, a fusion process, and a downdraw process. The float process is especially preferred because it is suitable for mass production. Continuous processes other than the float process, such as, for example, a fusion process and a downdraw process, are also preferred.

Thereafter, the formed glass is ground and polished according to need to form a glass substrate. In cases when the glass substrate is to be cut into a given shape and size or is to be chamfered, it is preferred to perform the cutting or chamfering of the glass substrate before the chemical strengthening treatment which will be described later is given thereto. This is because a compressive stress layer is formed also in the end surfaces by the subsequent chemical strengthening treatment.

The chemical strengthening in the method of the present invention for producing a chemically strengthened glass is chemical strengthening with a strengthening salt which includes sodium and has a potassium content of less than 5 mass %. In the method of the present invention for producing a chemically strengthened glass, the chemical strengthening treatment may include two or more stages. However, one-stage strengthening is preferred from the standpoint of heightening the production efficiency.

In the method of the present invention for producing a chemically strengthened glass, a lithium aluminosilicate glass having a K1c of 0.80 MPa·m^{1/2} or more is chemically strengthened with the strengthening salt, thereby obtaining a chemically strengthened glass having a CS₀ of 500-1,000 MPa and having a DOL [unit: μm], with respect to the thickness t [unit: μm] of the glass, of 0.06 t to 0.2 t.

The chemical strengthening treatment is conducted, for example, by immersing the glass sheet for 0.1-500 hours in a molten salt, e.g., sodium nitrate, heated to 360-600° C. The heating temperature of the molten salt is preferably 375-500° C. The period of immersion of the glass sheet in the molten salt is preferably 0.3-200 hours.

The strengthening salt to be used in the method of the present invention for producing a chemically strengthened glass is a strengthening salt which includes sodium and has a potassium content of less than 5 mass % in terms of potassium nitrate content. The potassium content thereof is preferably less than 2 mass %, and it is more preferable that the strengthening salt contains substantially no potassium. The expression “containing substantially no potassium” means that the strengthening salt does not contain potassium at all or that the strengthening salt may contain potassium as an impurity which has come unavoidably thereinto during production.

Examples of the strengthening salt include nitrates, sulfates, carbonates, and chlorides. Examples of the nitrates, among these, include lithium nitrate and sodium nitrate. Examples of the sulfates include lithium sulfate and sodium sulfate. Examples of the carbonates include lithium carbonate and sodium carbonate. Examples of the chlorides include lithium chloride, sodium chloride, cesium chloride, and silver chloride. One of these strengthening salts may be used alone, or two or more thereof may be used in combination.

Treatment conditions for the chemical strengthening treatment may be suitably selected while taking account of the composition (properties) of the glass, kind of the molten salt, desired chemical strengthening properties, etc.

### EXAMPLES

The present invention is described below using Examples, but the present invention is not limited by the following Examples. G1 to G26 are amorphous glasses, and GC1 to GC19 are glass ceramics. SG1 to SG21, SG25, SG31, and SG32 are examples of the chemically strengthened glasses of the present invention, and SG22 to SG24 and SG26 to SG30 are comparative examples. With respect to examination results in the tables, each blank indicates that the property was not determined.

### Preparation and Evaluation of Amorphous Glasses

Raw materials for glass were mixed so as to result in each of the glass compositions shown in Tables 1 to 3 in mole percentage on an oxide basis, and the mixtures were melted and polished to prepare glass sheets. The raw materials for a glass were suitably selected from among general raw materials for glass such as oxides, hydroxides, and carbonates, and weighed out so as to result in 900 g each of glasses. Each mixture of raw materials for glass was put in a platinum crucible and melted and degassed at 1,700° C. The resultant glass was poured onto a carbon board to obtain a glass block. A part of each of the obtained blocks was used to evaluate the amorphous glass for Young's modulus, Vickers hardness, and fracture toughness value. The results thereof are shown in Tables 1 to 3. Each blank in the tables indicates that the property was not evaluated.

### Young's Modulus

Young's modulus was measured by an ultrasonic wave method.

### Vickers Hardness

Vickers hardness was measured in accordance with the test method specified in JIS-Z-2244 (2009) (ISO 6507-1, ISO 6507-4, ASTM-E-384) using a Vickers hardness meter (MICRO HARDNESS TESTERHMV-2) manufactured by Shimadzu Corp. in an ordinary-temperature ordinary-humidity environment (in this case, the temperature and the humidity were kept at 25° C. and 60% RH). The measurement was made on ten portions per sample, and an average for the ten portions was taken as the Vickers hardness of the sample. The Vickers indenter was forced into the sample for 15 seconds at an indenting load of 0.98 N.

### Fracture Toughness Value

A sample having dimensions of 6.5 mm×6.5 mm×65 mm was prepared and examined for fracture toughness value by a DCDC method. In preparation for the evaluation, a through hole having a diameter of 2 mm was formed in 65 mm×6.5 mm surface of the sample.

TABLE 1

| Amorphous glass | G1 | G2 | G3 | G4 | G5 | G6 | G7 | G8 | G9 | G10 | G11 |
|---|---|---|---|---|---|---|---|---|---|---|---|
| SiO₂ | 54.9 | 54.9 | 52.9 | 51.9 | 50.9 | 50.9 | 51.5 | 50.5 | 53.0 | 52.0 | 52.0 |
| Al₂O₃ | 1.1 | 1.1 | 1.1 | 1.1 | 1.1 | 1.1 | 3.0 | 4.0 | 3.0 | 3.0 | 4.0 |
| Li₂O | 34.1 | 34.1 | 34.1 | 34.1 | 34.1 | 34.1 | 34.1 | 34.1 | 34.1 | 34.1 | 34.1 |
| Na₂O | 1.8 | 3.0 | 5.0 | 3.6 | 5.0 | 6.5 | 4.0 | 4.0 | 1.8 | 1.8 | 1.8 |
| K₂O | 1.2 | 0.0 | 0.0 | 2.4 | 2.0 | 0.5 | 0.5 | 0.5 | 1.2 | 1.2 | 1.2 |
| MgO | 0.0 | 0.0 | 0.0 | 0.0 | 0.0 | 0.0 | 0.0 | 0.0 | 0.0 | 0.0 | 0.0 |
| CaO | 0.0 | 0.0 | 0.0 | 0.0 | 0.0 | 0.0 | 0.0 | 0.0 | 0.0 | 0.0 | 0.0 |
| P₂O₅ | 2.3 | 2.3 | 2.3 | 2.3 | 2.3 | 2.3 | 2.3 | 2.3 | 2.3 | 2.3 | 2.3 |
| ZrO₂ | 4.5 | 4.5 | 4.5 | 4.5 | 4.5 | 4.5 | 4.5 | 4.5 | 4.5 | 4.5 | 4.5 |
| Y₂O₃ | 0.0 | 0.0 | 0.0 | 0.0 | 0.0 | 0.0 | 0.0 | 0.0 | 0.0 | 1.0 | 0.0 |
| TiO₂ | 0.0 | 0.0 | 0.0 | 0.0 | 0.0 | 0.0 | 0.0 | 0.0 | 0.0 | 0.0 | 0.0 |
| B₂O₃ | 0.0 | 0.0 | 0.0 | 0.0 | 0.0 | 0.0 | 0.0 | 0.0 | 0.0 | 0.0 | 0.0 |
| Young's modulus (GPa) | 87 | 88 | 89 | 89 | 90 | 91 | 90 | 91 | 87 | 90 | 91 |
| Vickers hardness | 604 | 599 | 610 | 602 | 601 | 621 | 603 | 604 | 587 | 609 | 592 |
| Fracture toughness value (MPa · m^{1/2}) | 0.72 | 0.71 | 0.72 | 0.73 | 0.72 | 0.72 | 0.73 | 0.71 | 0.70 | 0.72 | 0.71 |
| Poisson's ratio | 0.24 | 0.24 | 0.24 | 0.24 | 0.24 | 0.24 | 0.24 | 0.24 | 0.24 | 0.25 | 0.24 |

TABLE 2

| Amorphous glass | G12 | G13 | G14 | G15 | G16 | G17 | G18 | G19 | G20 | G21 |
|---|---|---|---|---|---|---|---|---|---|---|
| SiO₂ | 51.0 | 50.0 | 53.4 | 56.4 | 46.0 | 65.1 | 52.1 | 56.7 | 46.3 | 70.0 |
| Al₂O₃ | 4.0 | 5.0 | 1.1 | 1.1 | 1.0 | 3.6 | 1.1 | 1.1 | 1.1 | 7.5 |
| Li₂O | 34.1 | 34.1 | 34.1 | 34.1 | 43.7 | 20.5 | 35.3 | 34.1 | 34.6 | 8.0 |
| Na₂O | 1.8 | 1.8 | 1.8 | 1.8 | 1.7 | 2.0 | 1.9 | 0.1 | 1.8 | 5.3 |
| K₂O | 1.2 | 1.2 | 1.2 | 1.2 | 1.1 | 1.3 | 1.2 | 1.2 | 1.2 | 1.0 |
| MgO | 0.0 | 0.0 | 0.0 | 0.0 | 0.0 | 0.0 | 0.0 | 0.0 | 0.0 | 7.0 |
| CaO | 0.0 | 0.0 | 0.0 | 0.0 | 0.0 | 0.0 | 0.0 | 0.0 | 0.0 | 0.2 |
| P₂O₅ | 2.3 | 2.3 | 2.3 | 2.3 | 2.2 | 2.6 | 2.4 | 2.3 | 2.3 | 0.0 |
| ZrO₂ | 4.5 | 4.5 | 6.0 | 3.0 | 4.3 | 5.0 | 4.7 | 4.5 | 4.6 | 1.0 |
| Y₂O₃ | 1.0 | 1.0 | 0.0 | 0.0 | 0.0 | 0.0 | 1.3 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| B₂O₃ | 0.0 | 0.0 | 0.0 | 0.0 | 0.0 | 0.0 | 0.0 | 0.0 | 8.1 | 0.0 |
| SrO | 0.0 | 0.0 | 0.0 | 0.0 | 0.0 | 0.0 | 0.0 | 0.0 | 0.0 | 8.0 |
| SnO₂ | 0.0 | 0.0 | 0.0 | 0.0 | 0.0 | 0.0 | 0.0 | 0.0 | 0.0 | 5.3 |
| Young's modulus (GPa) | 91 | 92 | 91 | 87 | 93 | 85 | 92 | 91 | 82 | 80 |
| Vickers hardness | 631 | 621 | 621 | 587 | 621 | 582 | 621 | 603 | 576 | 550 |
| Fracture toughness value (MPa · m^{1/2}) | 0.73 | 0.72 | 0.72 | 0.69 | 0.73 | 0.70 | 0.73 | 0.72 | 0.75 | 0.80 |
| Poisson's ratio | 0.25 | 0.25 | 0.25 | 0.25 | 0.23 | 0.25 | 0.24 | 0.24 | 0.25 | 0.22 |

TABLE 3

| Amorphous glass | G22 | G23 | G24 | G25 | G26 |
|---|---|---|---|---|---|
| SiO₂ | 53.6 | 48.8 | 50.0 | 50.0 | 56.5 |
| Al₂O₃ | 32.1 | 30.5 | 30.0 | 27.2 | 28.3 |
| Li₂O | 10.7 | 9.1 | 10.0 | 13.6 | 11.3 |
| Na₂O | 0.0 | 1.0 | 0.0 | 0.0 | 0.0 |
| K₂O | 0.0 | 0.0 | 0.0 | 0.0 | 0.0 |
| MgO | 0.0 | 0.0 | 0.0 | 0.0 | 0.0 |
| CaO | 0.0 | 0.0 | 0.0 | 0.0 | 0.0 |
| P₂O₅ | 0.0 | 5.1 | 0.0 | 0.0 | 0.0 |
| ZrO₂ | 0.0 | 2.0 | 0.0 | 0.0 | 0.0 |
| Y₂O₃ | 3.6 | 2.3 | 10.0 | 9.1 | 3.8 |
| TiO₂ | 0.0 | 0.0 | 0.0 | 0.0 | 0.0 |
| B₂O₃ | 0.0 | 0.0 | 0.0 | 0.0 | 0.0 |
| SrO | 0.0 | 0.0 | 0.0 | 0.0 | 0.0 |
| SnO₂ | 0.0 | 0.0 | 0.0 | 0.0 | 0.0 |
| Young's modulus (GPa) | 105 | 103 | 117 | 112 | 104 |
| Vickers hardness | 740 | 645 | 760 | 680 | 731 |
| Fracture toughness value | 0.97 | 0.93 | 0.97 | 0.95 | 0.94 |
| (MPa · m^{1/2}) | | | | | |
| Poisson's ratio | 0.26 | 0.25 | 0.26 | 0.25 | 0.26 |

### Preparation of Glass Ceramics

The obtained glass blocks were processed into 50 mm×50 mm×1.5 mm and then heat-treated under the conditions shown in Tables 4 and 5 to obtain glass ceramics. In the row “Crystallization conditions” in each table, the upper portion shows conditions for nucleus formation treatment and the lower portion shows conditions for crystal growth treatment. For example, “550-2” in the upper portion and “730-2” in the lower portion mean that the glass was held at 550° C. for 2 hours and then held at 730° C. for 2 hours. A part of each of the obtained glass ceramics was used to ascertain, by X-ray powder diffractometry, that lithium metasilicate was contained.

The obtained glass ceramics were processed and mirror-polished to obtain glass-ceramic sheets having a thickness t of 0.7 mm (700 μm). A part of each remaining glass ceramic was pulverized and used for analyzing precipitated crystals. The results of the evaluation of the glass ceramics are shown in Tables 4 and 5, in which each blank shows that the property was not evaluated.

### Visible-Light Transmittance

Using a spectrophotometer (LAMBDA950, manufactured by PerkinElmer, Inc.) and a 150 mm integrating-sphere unit as a detector, each glass-ceramic sheet was examined for transmittance over a wavelength range of 380-780 nm, with the glass-ceramic sheet being kept in close contact with the integrating sphere. The average transmittance which was an arithmetic average of the transmittances is shown as the visible-light transmittance [unit: %].

### Haze

A hazemeter (HZ-V3, manufactured by Suga Test Instruments Co., Ltd.) was used to measure haze [unit: %] under an illuminant C.

### X-Ray Diffractometry: Precipitated Crystals and Degree of Crystallization

Each sample was examined by X-ray powder diffractometry under the following conditions to identify the precipitated crystals. Furthermore, the degree of crystallization was calculated from the obtained diffraction intensities by the Rietveld method.

Measuring apparatus: SmartLab, manufactured by Rigaku Corp.

X-ray used: CuKα ray

Measuring range: 2θ=10°−80°

Speed: 10° C./min

Step: 0.02°

The detected crystals are shown in the row “Main crystals” in Tables 4 and 5, in which LS indicates lithium metasilicate.

TABLE 4

| Glass ceramic | GC1 | GC2 | GC3 | GC4 | GC5 | GC6 | GC7 | GC8 | GC9 | GC10 | GC11 |
|---|---|---|---|---|---|---|---|---|---|---|---|
| Glass composition | G1 | G2 | G3 | G4 | G5 | G6 | G7 | G8 | G9 | G10 | G11 |
| Tg before crystallization (° C.) | 453 | 456 | 443 | 439 | 430 | 428 | 450 | 460 | 469 | 470 | 467 |
| Heat-treatment conditions | 550-2 | 550-2 | 550-2 | 550-2 | 550-2 | 550-2 | 550-2 | 550-2 | 550-2 | 550-2 | 550-2 |
| (° C.-hour) | 730-2 | 710-2 | 710-2 | 710-2 | 710-2 | 670-2 | 730-2 | 710-2 | 730-2 | 710-2 | 690-2 |
| Visible-light transmittance (%) | 91.2 | 91.4 | 90.9 | 91.4 | 91.3 | 91.8 | 91.2 | 90.7 | 90.9 | 91.5 | 91.3 |
| Haze (%) | 0.08 | 0.08 | 0.09 | 0.07 | 0.11 | 0.09 | 0.07 | 0.08 | 0.07 | 0.08 | 0.08 |
| Young's modulus (GPa) | 104 | 104 | 106 | 105 | 110 | 103 | 104 | 102 | 102 | 104 | 102 |
| Vickers hardness | 801 | 753 | 782 | 762 | 770 | 812 | 807 | 759 | 823 | 764 | 813 |
| Poisson's ratio | 0.23 | 0.23 | 0.22 | 0.21 | 0.23 | 0.22 | 0.22 | 0.23 | 0.21 | 0.23 | 0.22 |
| Fracture toughness value (MPa · m^{1/2}) | 0.93 | 0.92 | 0.93 | 0.91 | 0.94 | 0.95 | 0.91 | 0.92 | 0.91 | 0.89 | 0.93 |
| Main crystals | LS | LS | LS | LS | LS | LS | LS | LS | LS | LS | LS |
| Degree of crystallization (%) | 23 | 21 | 24 | 23 | 25 | 26 | 19 | 24 | 21 | 18 | 26 |

TABLE 5

| Glass ceramic | GC12 | GC13 | GC14 | GC15 | GC16 | GC17 | GC18 | GC19 |
|---|---|---|---|---|---|---|---|---|
| Glass composition | G12 | G13 | G14 | G15 | G1 | G1 | G13 | G13 |
| Tg before crystallization (° C.) | 468 | 471 | 465 | 448 | 453 | 453 | 471 | 471 |
| Heat-treatment conditions | 550-2 | 550-2 | 550-2 | 550-2 | 550-2 | 550-2 | 550-2 | 550-2 |
| (° C.-hour) | 710-2 | 730-2 | 750-2 | 710-2 | 650-2 | 750-2 | 690-2 | 750-2 |
| Visible-light transmittance (%) | 91.5 | 91.3 | 90.9 | 91.2 | 92 | 90.3 | 92.1 | 91.2 |
| Haze (%) | 0.1 | 0.09 | 0.1 | 0.08 | 0.03 | 0.2 | 0.03 | 0.21 |
| Young's modulus (GPa) | 105 | 105 | 109 | 103 | 101 | 105 | 98 | 110 |
| Vickers hardness | 818 | 823 | 749 | 762 | 723 | 788 | 742 | 841 |
| Poisson's ratio | 0.22 | 0.23 | 0.21 | 0.22 | 0.23 | 0.22 | 0.23 | 0.21 |
| Fracture toughness value (MPa · m^{1/2}) | 0.90 | 0.91 | 0.89 | 0.88 | 0.83 | 0.95 | 0.90 | 0.95 |
| Main crystals | LS | LS | LS | LS | LS | LS | LS | LS |
| Degree of crystallization (%) | 21 | 19 | 21 | 23 | 22 | 29 | 8 | 28 |

### Preparation of Chemically Strengthened Glasses

GC1 to GC19 and G22 to G26 were subjected to chemical strengthening treatments under the strengthening conditions shown in Tables 6 to 9 to obtain strengthened glasses SG1 to SG32. SG 1 to SG21, SG25, SG31, and SG32 are working examples, and SG22 to SG24 and SG26 to SG30 are comparative examples. In Tables 6 to 9, “Na100%” indicates a molten salt consisting of 100% sodium nitrate, “Na 99.7% Li 0.3%” indicates a molten salt obtained by mixing 99.7 wt % sodium nitrate with 0.3 wt % lithium nitrate, and “K100%” means a molten salt consisting of 100% potassium nitrate. The obtained chemically strengthened glasses were evaluated, and the results thereof are shown in Tables 6 to 9, in which each blank shows that the property was not evaluated.

### Stress Profile

Stress values were measured using measuring device SLP-2000, manufactured by Orihara Industrial Co., Ltd., to read out a compressive stress value CS₀ [unit: MPa] in a glass surface, a compressive stress value CS₅₀ [unit: MPa] at a depth of 50 and a depth DOL [unit: μm] where the compressive stress value is zero. The results thereof are shown in Tables 6 to 9.

A stress profile of SG5 is shown in FIG. 1. The Reference Example in FIG. 1 is a stress profile of a chemically strengthened glass obtained by subjecting G21 (amorphous glass), which is shown in Table 2, to two-stage chemical strengthening without crystallization. The two-stage chemical strengthening was conducted under such conditions that G21 was subjected to 2.5-hour first-stage chemical strengthening with 100% sodium nitrate at 450° C. and then to 1.5-hour second-stage chemical strengthening with 100% potassium nitrate at 450° C.

### EPMA Surface K Concentration

The K concentration of a glass surface was determined using an EPMA (JXA-8500F, manufactured by JEOL Ltd.). A sample was chemically strengthened and then embedded in a resin, and a section thereof perpendicular to the main surfaces was mirror-polished. Since the concentration in an outermost surface is difficult to determine accurately, it was assumed that the intensity of signals of K in a position where the intensity of signals of Si, which is thought to change little in content, was one-half the signal intensity at the sheet-thickness center corresponded to the concentration of K in the outermost surface. Assuming that the signal intensity at the sheet-thickness center corresponded to the glass composition of before the strengthening, the concentration of K in the outermost surface was calculated.

### Weatherability Test

A sample was allowed to stand for 120 hours at 80° C. and a humidity of 80% and then examined for haze. Although not changed by a chemical strengthening treatment, the haze increases upon 120-hour standing at 80° C. and a humidity of 80%. The difference in haze between before and after the test (i.e., |(haze [%] after test)−(haze [%] before test)|) is shown as [Haze change (%)] in the tables.

### Number of Fragments

Using a Vickers tester, a Vickers indenter having a tip angle of 90° was forced into a center portion of a test glass sheet to fracture the glass sheet. The number of fragments was counted. (If the glass sheet was broken into two pieces, the number of fragments is 2.) In cases when exceedingly fine fragments were formed, only fragments which did not pass through a 1-mm sieve were counted to determine the number of fragments. The test was initiated with a Vickers-indenter indenting load of 3 kgf. In cases when the glass sheet did not break, the indenting load was increased by 1 kgf, and the test was repeated until the glass sheet broke. The number of fragments was counted at the time of first breakage.

### Drop Test

In a drop test, an obtained glass sample having dimensions of 120 mm×60 mm×0.6 mm (thickness) was fitted into a structure regulated so as to have the size, mass, and rigidity of a general smartphone in current use. A pseudo smartphone was thus prepared and dropped freely onto #180 SiC sandpaper. The pseudo smartphone was dropped from a height of 5 cm, and in cases when the glass did not break, the pseudo smartphone was dropped again from a height elevated by 5 cm. This operation was repeated until the glass broke. The height which resulted in first breakage was determined, and an average for ten glass sheets is shown in Tables 6 to 9.

TABLE 6

| Chemically strengthened glass | SG1 | SG2 | SG3 | SG4 | SG5 | SG6 | SG7 | SG8 | SG9 | SG10 | SG11 |
|---|---|---|---|---|---|---|---|---|---|---|---|
| Glass for strengthening | GC1 | GC2 | GC3 | GC4 | GC5 | GC6 | GC7 | GC8 | GC9 | GC10 | GC11 |
| Conditions for first-stage strengthening | Na100% | Na100% | Na100% | Na100% | Na100% | Na100% | Na100% | Na100% | Na100% | Na100% | Na100% |
| | 450° C. | 450° C. | 450° C. | 450° C. | 450° C. | 450° C. | 450° C. | 450° C. | 450° C. | 450° C. | 450° C. |
| | 1.5 hour | 1.5 hour | 1.5 hour | 1.5 hour | 1.5 hour | 1.5 hour | 1.5 hour | 1.5 hour | 1.5 hour | 1.5 hour | 1.5 hour |
| Conditions for second-stage strengthening | none | none | none | none | none | none | none | none | none | none | none |
| Thickness t (μm) | 700 | 700 | 700 | 700 | 700 | 700 | 700 | 700 | 700 | 700 | 700 |
| CS₀ (MPa) | 650 | 630 | 660 | 620 | 670 | 680 | 600 | 680 | 640 | 650 | 640 |
| CS₅₀ (MPa) | 170 | 160 | 160 | 150 | 170 | 160 | 160 | 160 | 160 | 170 | 160 |
| CT (MPa) | 82 | 81 | 81 | 80 | 84 | 80 | 79 | 80 | 81 | 83 | 81 |
| St (μm · MPa) | 20664 | 20412 | 20777 | 20160 | 21546 | 20880 | 19553 | 20880 | 20412 | 20543 | 20412 |
| 2St/(t-2DOL) = ICT (MPa) | 73.8 | 72.9 | 72.9 | 72 | 75.6 | 72 | 71.1 | 72 | 72.9 | 74.7 | 72.9 |
| DOL (μm) | 70 | 70 | 65 | 70 | 65 | 60 | 75 | 60 | 70 | 75 | 70 |
| DOL/t | 0.10 | 0.10 | 0.09 | 0.10 | 0.09 | 0.09 | 0.11 | 0.09 | 0.10 | 0.11 | 0.10 |
| (t-2DOL)CT/2 (μm · MPa) | 22960 | 22680 | 23085 | 22400 | 23940 | 23200 | 21725 | 23200 | 22680 | 22825 | 22680 |
| (CS₀ × DOL)/K1c (μm/m^{1/2}) | 48925 | 47935 | 46129 | 47692 | 46330 | 42947 | 49451 | 44348 | 49231 | 54775 | 48172 |
| X | 95 | 94 | 94 | 92 | 96 | 95 | 94 | 93 | 92 | 92 | 94 |
| CT/X | 0.86 | 0.86 | 0.86 | 0.87 | 0.88 | 0.84 | 0.84 | 0.86 | 0.88 | 0.90 | 0.86 |
| EPMA surface K concentration (wt %) | 0.2 | 0 | 0 | 0.4 | 0.2 | 0.1 | 0.1 | 0.2 | 0.2 | 0.1 | 0.3 |
| Weatherability [Haze change (%)] | 1.1 | 0.5 | 0.4 | 1.5 | 1.7 | 1.0 | 0.9 | 0.8 | 1.4 | 1.4 | 1.6 |
| Number of fragments | 7 | 6 | 8 | 10 | 8 | 7 | 9 | 6 | 9 | 9 | 6 |
| Drop test (cm) | 97 | 93 | 94 | 89 | 98 | 97 | 92 | 93 | 92 | 92 | 94 |

TABLE 7

| Chemically strengthened glass | SG12 | SG13 | SG14 | SG15 | SG16 | SG17 | SG18 | SG19 |
|---|---|---|---|---|---|---|---|---|
| Glass for strengthening | GC12 | GC13 | GC14 | GC15 | GC16 | GC17 | GC18 | GC19 |
| Conditions for first-stage strengthening | Na100% | Na100% | Na100% | Na100% | Na100% | Na100% | Na100% | Na100% |
| | 450° C. | 450° C. | 450° C. | 450° C. | 450° C. | 450° C. | 450° C. | 450° C. |
| | 1.5 hour | 1.5 hour | 1.5 hour | 1.5 hour | 1.5 hour | 1.5 hour | 1.5 hour | 1.5 hour |
| Conditions for second-stage strengthening | none | none | none | none | none | none | none | none |
| Thickness t (μm) | 700 | 700 | 700 | 700 | 700 | 700 | 700 | 700 |
| CS₀ (MPa) | 700 | 710 | 650 | 660 | 610 | 770 | 600 | 760 |
| CS₅₀ (MPa) | 170 | 180 | 170 | 160 | 160 | 200 | 160 | 210 |
| CT (MPa) | 81 | 81 | 83 | 82 | 75 | 84 | 80 | 84 |
| St (μm · MPa) | 21141 | 21141 | 20916 | 21033 | 18225 | 21546 | 19440 | 21168 |
| DOL (μm) | 60 | 60 | 70 | 65 | 80 | 65 | 80 | 70 |
| DOL/t | 0.09 | 0.09 | 0.10 | 0.09 | 0.11 | 0.09 | 0.11 | 0.10 |
| (t-2DOL)CT/2 (μm · MPa) | 23490 | 23490 | 23240 | 23370 | 20250 | 23940 | 21600 | 23520 |
| (CS₀ × DOL)/K1c (μm/m^{1/2}) | 46667 | 46813 | 51124 | 48750 | 58795 | 52684 | 53333 | 56000 |
| X | 90 | 92 | 90 | 89 | 87 | 96 | 94 | 96 |
| CT/X | 0.90 | 0.88 | 0.92 | 0.92 | 0.86 | 0.87 | 0.85 | 0.87 |
| EPMA surface K concentration (wt %) | 0.1 | 0.1 | 0.1 | 0.2 | 0.1 | 0.1 | 0.2 | 0.1 |
| [Haze change (%)] | 1.4 | 1.5 | 1.4 | 1.3 | 2.3 | 1.8 | 1.2 | 0.9 |
| Number of fragments | 6 | 6 | 9 | 7 | 10 | 9 | 9 | 10 |
| Drop test (cm) | 93 | 97 | 92 | 88 | 82 | 107 | 97 | 114 |

TABLE 8

| Chemically strengthened glass | SG13 | SG20 | SG21 | SG22 | SG23 | SG24 |
|---|---|---|---|---|---|---|
| Glass for strengthening | GC13 | GC13 | GC13 | GC13 | GC13 | GC13 |
| Conditions for first-stage strengthening | Na100% | Na99.8% Li0.2% | Na99.7% Li0.3% | Na99.4% Li0.6% | Na100% | Na100% |
| | 450° C. | 450° C. | 450° C. | 450° C. | 450° C. | 450° C. |
| | 1.5 hour | 2 hour | 2.5 hour | 2.5 hour | 1.5 hour | 1.5 hour |
| Conditions for second-stage strengthening | none | none | none | none | K100% | K100% |
| | | | | | 450° C. | 450° C. |
| | | | | | 4 hour | 2 hour |
| Thickness t (μm) | 700 | 700 | 700 | 700 | 700 | 700 |
| CS₀ (MPa) | 710 | 640 | 600 | 550 | 750 | 780 |
| CS₅₀ (MPa) | 180 | 180 | 200 | 160 | 160 | 170 |
| CT (MPa) | 81 | 81 | 83 | 76 | 80 | 80 |
| St (μm · MPa) | 21141 | 20412 | 20169 | 19494 | 16560 | 17640 |
| DOL (μm) | 60 | 70 | 80 | 65 | 120 | 105 |
| (t-2DOL)CT/2 (μm · MPa) | 23490 | 22680 | 22410 | 21660 | 18400 | 19600 |
| (CS₀ × DOL)/K1c (μm/m^{1/2}) | 46813 | 49231 | 52747 | 39286 | 98901 | 90000 |
| X | 92 | 93 | 95 | 93 | 103 | 100 |
| CT/X | 0.88 | 0.87 | 0.87 | 0.82 | 0.78 | 0.80 |
| EPMA surface K concentration (wt %) | 0.1 | 0.1 | 0.1 | 0.2 | 18 | 16 |
| [Haze change (%)] | 1.5 | 0.9 | 0.6 | 0.3 | 31 | 24 |
| Number of fragments | 6 | 7 | 7 | 1 | 8 | 7 |
| Drop test (cm) | 97 | 97 | 102 | 92 | 92 | 94 |

TABLE 9

| Chemically strengthened glass | SG25 | SG26 | SG27 | SG28 | SG29 | SG30 | SG31 | SG32 |
|---|---|---|---|---|---|---|---|---|
| Glass for strengthening | G22 | G23 | G23 | G23 | G24 | G24 | G25 | G26 |
| Conditions for first-stage strengthening | Na100% | Na100% | Na100% | Na100% | Na100% | Na100% | Na100% | Na100% |
| | 450° C. | 450° C. | 450° C. | 450° C. | 450° C. | 450° C. | 450° C. | 450° C. |
| | 14 h | 10 h | 13 h | 16 h | 175 h | 300 h | 36 h | 12 h |
| Conditions for second-stage strengthening | none | none | none | none | none | none | none | none |
| Thickness t (μm) | 700 | 700 | 700 | 700 | 700 | 700 | 700 | 700 |
| CS₀ (MPa) | 936 | 488 | 504 | 471 | 976 | 1044 | 765 | 768 |
| CS₅₀ (MPa) | 198 | 145 | 177 | 197 | 51 | 199 | 178 | 198 |
| CT (MPa) | 90 | 93 | 105 | 122 | 87 | 137 | 86 | 85 |
| St (μm · MPa) | 22599 | 22264 | 24287 | 27285 | 22864 | 34092 | 21285 | 20579 |
| DOL (μm) | 71 | 84 | 93 | 101.5 | 58 | 73.5 | 75 | 81 |
| (t-2DOL)CT/2 (μm · MPa) | 25110 | 24738 | 26985 | 30317 | 25404 | 37881 | 23650 | 22865 |
| (CS₀ × DOL)/K1c (μm/m^{1/2}) | 68511 | 44077 | 50400 | 51405 | 58359 | 79107 | 60395 | 66179 |
| X | 102 | 99 | 101 | 103 | 99 | 102 | 100 | 100 |
| CT/X | 0.88 | 0.94 | 1.04 | 1.19 | 0.87 | 1.34 | 0.86 | 0.85 |
| EPMA surface K concentration (wt %) | 0 | 0 | 0 | 0 | 0 | 0 | 0 | 0 |
| [Haze change (%)] | 0 | 0 | 0 | 0 | 0 | 0 | 0 | 0 |
| Number of fragments | 6 | 7 | 50 or | 50 or | 2 | 50 or | 8 | 9 |
| | | | more | more | | more | | |
| Drop test (cm) | 101 | 77 | 92 | 106 | 40 | 112 | 93 | 104 |

As Tables 6 to 9 show, the chemically strengthened glasses of the present invention were found to be equal in CS₀ and CS₅₀ to the comparative examples to show excellent strength and had smaller DOLs than the comparative examples to be less apt to fracture upon reception of damage. Furthermore, the chemically strengthened glasses of the present invention had smaller haze changes through the weatherability test than the comparative examples to show excellent weatherability.

While the present invention has been described in detail and with reference to specific embodiments thereof, it will be apparent to one skilled in the art that various changes and modifications can be made therein without departing from the spirit and scope thereof

1. A method of producing a chemically strengthened glass, the method comprising chemically strengthening a lithium aluminosilicate glass having a thickness oft [unit: μm],
wherein the lithium aluminosilicate glass has a fracture toughness value (K1c) of 0.80 MPa·m^{1/2} or more,
the chemical strengthening is chemical strengthening with a strengthening salt comprising sodium and having a potassium content of less than 5 mass %, and
a chemically strengthened glass to be obtained has a surface compressive stress value (CS₀) of 500-1,000 MPa and has a depth DOL [unit: μm] at which a compressive stress value is zero of 0.06 t to 0.2 t.

2. The method of producing a chemically strengthened glass according to claim 1, wherein the lithium aluminosilicate glass is a glass ceramic.

3. The method of producing a chemically strengthened glass according to claim 2, wherein the glass ceramic comprises, in mole percentage on an oxide basis:
40-72% of SiO₂;
0.5-10% of Al₂O₃; and
15-50% of Li₂O.

4. The method of producing a chemically strengthened glass according to claim 2, wherein the glass ceramic has a visible-light transmittance as converted into a value corresponding to a thickness of 0.7 mm of 85% or more.

5. The method of producing a chemically strengthened glass according to claim 2, wherein the glass ceramic comprises lithium metasilicate crystals.

6. The method of producing a chemically strengthened glass according to claim 1, wherein the lithium aluminosilicate glass comprises, in mole percentage on an oxide basis:
40-65% of SiO₂;
15-45% of Al₂O₃; and
2-15% of Li₂O.

7. A chemically strengthened glass having a thickness of t [unit: μm],
being a lithium aluminosilicate glass,
having a surface compressive stress value (CS₀) of 500-1,000 MPa,
having a compressive stress value (CS₅₀) at a depth of 50 μm from a glass surface of 150-230 MPa,
having a depth DOL [unit: μm] at which a compressive stress value is zero of 0.06 t to 0.2 t, and
having a value of (CS₀ DOL)/K1c [unit: μm/m^{1/2}] of 40,000 to 70,000.

8. The chemically strengthened glass according to claim 7, wherein the surface thereof has a concentration of K of 1 mass % or less.

9. A chemically strengthened glass having a thickness oft [unit: μm],
being a lithium aluminosilicate glass,
having a surface compressive stress value (CS₀) of 500-1,000 MPa,
having a compressive stress value (CS₅₀) at a depth of 50 μm from a glass surface of 150-230 MPa, and
having a ratio CT/X of 0.7-1, where CT is an internal compressive stress value [unit: MPa] and X is represented by the following expression:
$$X = √ ( 1 \text{/} 2 a ( 1 - v ) ( t - 2 \times D O L ) ) K 1 c$$
where a=0.11,
v is Poisson's ratio [unit: −]
DOL is a depth [unit: μm] at which a compressive stress value is zero, and
K1c is a fracture toughness value [unit: MPa·m^{1/2}].

10. The chemically strengthened glass according to claim 7, wherein a base glass of the chemically strengthened glass is a glass ceramic having K1c of 0.85 MPa·m^{1/2} or more.

11. The chemically strengthened glass according to claim 10, wherein the glass ceramic comprises lithium metasilicate crystals.

12. The chemically strengthened glass according claim 10, wherein the glass ceramic comprises, in mole percentage on an oxide basis:
40-72% of SiO₂;
0.5-10% of Al₂O₃; and
15-50% of Li₂O, and
comprises substantially no K₂O.

13. The chemically strengthened glass according to claim 7, wherein a base glass of the chemically strengthened glass comprises, in mole percentage on an oxide basis, 40-65% of SiO₂, 15-45% of Al₂O₃, and 2-15% of Li₂O, and has K1c of 0.80 MPa·m^{1/2} or more.
